(19) United States
(12) Patent Application Publication
(10) Pub. No.: US 2018/0097222 A1
(43) Pub. Date: Apr. 5, 2018

(54) ELECTRODE MATERIAL FOR LITHIUM-ION SECONDARY BATTERY, ELECTRODE FOR LITHIUM-ION SECONDARY BATTERY, AND LITHIUM-ION SECONDARY BATTERY

(71) Applicant: SUMITOMO OSAKA CEMENT CO., LTD., Tokyo (JP)

(72) Inventors: Satoru OSHITARI, Tokyo (JP); Masataka OYAMA, Tokyo (JP); Naoyuki KUROSAWA, Tokyo (JP); Ryuuta YAMAYA, Tokyo (JP)

(21) Appl. No.: 15/470,397

(22) Filed: Mar. 27, 2017

(30) Foreign Application Priority Data
Sep. 30, 2016 (JP) 2016-192878

(51) Int. Cl. H01M 4/134; H01M 4/48; H01M 4/50; H01M 4/52; H01M 10/052

(52) U.S. Cl. CPC H01M 4/134; H01M 4/483; H01M 10/052; H01M 4/523; H01M 4/502

(57) ABSTRACT

An electrode material for a lithium-ion secondary battery of the present invention is a mixture including an electrode active material A made of LiFeₓMn_{1-x-y}M_{y}PO₄ (0.05≦x≦0.40, 0≦y≦0.14, 1−x−y≧0, here, M represents at least one element selected from the group consisting of Mg, Ca, Co, Sr, Ba, Ti, Zn, B, Al, Ga, In, Si, Ge, and rare earth elements) and an electrode active material B made of a lithium-containing metal oxide, in which a volume change percentage due to lithium ions absorbed into and emitted from the electrode active material A is 6.2% or more and 8.3% or less.

### CROSS-REFERENCE TO RELATED APPLICATIONS

This application claims the benefit of Japanese Patent Application No. 2016-192878 filed Sep. 30, 2016, the disclosure of which is herein incorporated by reference in its entirety.

### BACKGROUND OF THE INVENTION

### Field of the Invention

The present invention relates to an electrode material for a lithium-ion secondary battery, an electrode for a lithium-ion secondary battery, and a lithium-ion secondary battery.

### Description of Related Art

Electrode materials made of a lamellar-structured three-component (Ni, Co, and Mn)-based metal oxide (hereinafter, referred to as “NMC”) have a high energy density, but the structure thereof is unstable in a charged state. There are cases in which lithium-ion secondary batteries including an electrode that includes NMC generate heat or ignite, and thus there is a demand for improvement in safety.

As one of methods for improving the safety of lithium-ion secondary batteries including an electrode that includes an oxide such as NMC, a method of using a mixture of an oxide and olivine-type lithium iron phosphate (LiFePO₄, hereinafter, in some cases, also referred to as “LFP”) or lithium manganese phosphate (LiMnPO₄, hereinafter, in some cases, also referred to as “LMP”) is known (for example, refer to PCT Japanese Translation Patent Publication No. 2014-524133). According to this method, NMC has an energy density that is slightly limited, but is capable of significantly enhancing safety.

Meanwhile, the volume change percentage during charge and discharge of NMC is less than 1%, but that of LMP is approximately 12% and that of LiFeₓMn_{1-x-y}M_{y}PO₄ (hereinafter, in some cases, also abbreviated as “LFMP”) is approximately 9%, and thus the volume change percentage of LMP or LFMP is greater than the volume change of NMC. Therefore, electrodes made of a mixture of NMC and LMP or LFMP have a problem of losing electrical conductivity due to volume changes in the middle of charge and discharge and thus shortening the service lives of batteries.

### SUMMARY OF THE INVENTION

The present invention has been made in consideration of the above-described circumstances, and an object of the present invention is to provide an electrode material for a lithium-ion secondary battery capable of improving safety in the case of being used as electrodes and capable of improving the service lives of batteries, an electrode for a lithium-ion secondary battery including this electrode material for a lithium-ion secondary battery, and a lithium-ion secondary battery including the electrode for a lithium-ion secondary battery.

The present inventors and the like carried out intensive studies in order to solve the above-described problem, consequently found that, when an electrode material for a lithium-ion secondary battery made of a mixture including an electrode active material A made of LiFeₓMn_{1-x-y}M_{y}PO₄ (0.05≦x≦0.40, 0≦y≦0.14, 1−x−y≧0, here, M represents at least one element selected from the group consisting of Mg, Ca, Co, Sr, Ba, Ti, Zn, B, Al, Ga, In, Si, Ge, and rare earth elements) and an electrode active material B made of a lithium-containing metal oxide is used, it is possible to improve safety in the case of being used as electrodes and improve the service lives of batteries, and completed the present invention.

An electrode material for a lithium-ion secondary battery of the present invention is a mixture including an electrode active material A made of LiFeₓMn_{1-x-y}M_{y}PO₄ (0.05≦x≦0.40, 0≦y≦0.14, 1−x−y≧0, here, M represents at least one element selected from the group consisting of Mg, Ca, Co, Sr, Ba, Ti, Zn, B, Al, Ga, In, Si, Ge, and rare earth elements) and an electrode active material B made of a lithium-containing metal oxide, in which a volume change percentage due to lithium ions absorbed into and emitted from the electrode active material A is 6.2% or more and 8.3% or less.

An electrode for a lithium-ion secondary battery of the present invention is an electrode for a lithium-ion secondary battery includes an electrode current collector and an electrode mixture layer formed on the electrode current collector, in which the electrode mixture layer includes the electrode material for a lithium-ion secondary battery of the present invention.

A lithium-ion secondary battery of the present invention includes the electrode for a lithium-ion secondary battery of the present invention.

According to the electrode material for a lithium-ion secondary battery of the present invention, it is possible to improve safety in the case of being used as electrodes and improve the service lives of batteries.

According to the electrode for a lithium-ion secondary battery of the present invention, since the electrode material for a lithium-ion secondary battery of the present invention is included, it is possible to provide an electrode for a lithium-ion secondary battery which has improved safety and is capable of improving the service lives of batteries.

According to the lithium-ion secondary battery of the present invention, since the electrode for a lithium-ion secondary battery of the present invention is included, it is possible to provide a lithium-ion secondary battery having improved safety and a long service life.

### DETAILED DESCRIPTION OF THE INVENTION

Embodiments of an electrode material for a lithium-ion secondary battery, an electrode for a lithium-ion secondary battery, and a lithium-ion secondary battery of the present invention will be described.

Meanwhile, the present embodiment is a specific description for easier understanding of the gist of the present invention and, unless particularly otherwise described, does not limit the present invention.

Electrode Material for Lithium-Ion Secondary Battery

An electrode material for a lithium-ion secondary battery of the present embodiment is a mixture including an electrode active material A made of LiFeₓMn_{1-x-y}M_{y}PO₄ (0.05≦x≦0.40, 0≦y≦0.14, 1−x−y≧0, here, M represents at least one element selected from the group consisting of Mg, Ca, Co, Sr, Ba, Ti, Zn, B, Al, Ga, In, Si, Ge, and rare earth elements) and an electrode active material B made of a lithium-containing metal oxide, in which the volume change percentage due to lithium ions absorbed into and emitted from the electrode active material A is 6.2% or more and 8.3% or less.

The electrode material for a lithium-ion secondary battery of the present embodiment is mainly used as cathode materials for lithium-ion secondary batteries.

In the electrode material for a lithium-ion secondary battery of the present embodiment, the volume change percentage due to lithium ions absorbed into and emitted from the electrode active material A is 6.2% or more and 8.3% or less and preferably 6.4% or more and 8.2% or less.

When the volume change percentage of the electrode material for a lithium-ion secondary battery of the present embodiment is less than 6.2%, the volume change percentage is a value that is significantly smaller than the theoretically-assumed volume change percentage of LiFeₓMn_{1-x-y}M_{y}PO₄, and thus the electrode material is assumed as a material having insufficient lithium ion absorption and emission performance so that side reactions are likely occur. On the other hand, in the electrode material for a lithium-ion secondary battery of the present embodiment, when the volume change percentage due to lithium ions absorbed into and emitted from the electrode active material A exceeds 8.3%, electrical conductivity is lost due to volume changes in the middle of the charge and discharge of lithium-ion secondary batteries including an electrode that includes the electrode material for a lithium-ion secondary battery of the present embodiment, and the service lives of batteries are shortened.

Meanwhile, in the electrode material for a lithium-ion secondary battery of the present embodiment, volume changes due to the absorption and emission of lithium ions are a phenomenon occurring during the charge and discharge of lithium-ion secondary batteries including an electrode for a lithium-ion secondary battery which includes the electrode material for a lithium-ion secondary battery of the present embodiment.

In the electrode material for a lithium-ion secondary battery of the present embodiment, the electrode active material A is preferably electrochemically active at near 4.0 V. The electrode active material B of the electrode material for a lithium-ion secondary battery of the present embodiment is a material that mainly reacts at 4.0 V or higher, and, in a case in which the reaction voltage of the electrode active material A is far higher than 4.0 V, the electrode active material B preferentially reacts during charging, and a sufficient safety improvement effect of the mixing of the electrode active material A and the electrode active material B cannot be obtained, which is not preferable. In a case in which the reaction voltage of the electrode active material A is far lower than 4.0 V, not only does the energy density derived from the electrode active material A decrease, but the electrode active material A also preferentially reacts during charging, and a sufficient safety improvement effect of the mixing of the electrode active material A and the electrode active material B cannot be obtained, which is not preferable.

In the electrode material for a lithium-ion secondary battery, the volume change percentage due to lithium ions absorbed into and emitted from the electrode active material A was computed in the following manner. The electrode active material A in the electrode material for a lithium-ion secondary battery in lithium ion absorption and desorption states is evaluated using an X-ray diffraction device (trade name: X'Pert PRO MPS, manufactured by PANalytical B.V., line source: CuKa), the lattice volumes of the electrode active material A in a non-charged state and a charged state were respectively computed from the X-ray diffraction pattern, and the volume change percentage was computed using (the lattice volume of lithium ions in the desorption state)/(the lattice volume of lithium ions in the absorption state).

In the electrode material for a lithium-ion secondary battery of the present embodiment, the content of the electrode active material A is preferably 5% by mass or more and 40% by mass or less and more preferably 7% by mass or more and 30% by mass or less.

When the content of the electrode active material A is less than 5% by mass, the improvement effect of electrodes including the mixture of the electrode active material A and the electrode active material B is not sufficient, which is not preferable. On the other hand, when the content of the electrode active material A exceeds 40% by mass, the decrease in the energy density due to the inclusion of the electrode active material A becomes significant, which is not preferable.

The mixing ratio (mass ratio) of the electrode active material A and the electrode active material B, that is, the mass ratio (the electrode active material B/the electrode active material A) of the electrode active material B to the electrode active material A is preferably 1.5 or more and 19 or less and more preferably 2.33 or more and 13.3 or less.

When the mass ratio (the electrode active material B/the electrode active material A) is less than 1.5, the improvement effect of electrodes including the mixture of the electrode active material A and the electrode active material B is not sufficient, which is not preferable. On the other hand, when the mass ratio (the electrode active material B/the electrode active material A) exceeds 19, the decrease in the energy density due to the inclusion of the electrode active material A becomes significant, which is not preferable.

In lithium-ion secondary batteries including an electrode for a lithium-ion secondary battery obtained by forming the electrode mixture layer on an electrode current collector using the electrode material for a lithium-ion secondary battery of the present embodiment, the capacity retention (=the discharge capacity at the 300^{th} cycle/the discharge capacity at the first cycle) at 25° C. and a 1CA discharge capacity is preferably 75% or more and 95% or less and more preferably 78% or more and 93% or less.

When the capacity retention of the discharge capacity is less than 75%, the discharge capacity excessively decreases, and thus the service lives of batteries are shortened, which is not preferable. On the other hand, when the capacity retention of the discharge capacity exceeds 95%, the capacity retention is a value that is higher than the assumed capacity retention, the improvement of the apparent capacity retention due to the low discharge capacity at the first cycle or an increase in the discharge capacity due to side reactions during discharging is concerned, which is not preferable.

Electrode Active Material A

The electrode active material A is made of LiFeₓMn_{1-x-y}M_{y}PO₄ having a crystal structure preferable for Li diffusion (0.05≦x≦0.40, 0≦y≦0.14, 1−x−y≧0, here, M represents at least one element selected from the group consisting of Mg, Ca, Co, Sr, Ba, Ti, Zn, B, Al, Ga, In, Si, Ge, and rare earth elements).

In LiFeₓMn_{1-x-y}M_{y}PO₄, the reasons for setting x to satisfy 0.05≦x≦0.40 are as described below. When x is less than 0.05, the Li diffusivity of the electrode active material A is insufficient, and thus the charge and discharge characteristics of electrodes including the mixture of the electrode active material A and the electrode active material B deteriorate. When x exceeds 0.40, the fraction of an Fe element included in the electrode active material A increases, and the energy density of the electrode active material A decreases, and thus the energy density of electrodes including the mixture of the electrode active material A and the electrode active material B decreases. In addition, the reasons for setting y to satisfy 0≦y≦0.14 are that M is an electrochemically inert element, and thus, when y exceeds 0.14, the energy density of the electrode active material A decreases, and thus the energy density of electrodes including the mixture of the electrode active material A and the electrode active material B decreases.

In LiFeₓMn_{1-x-y}M_{y}PO₄, M is an electrochemically inert element in a voltage range of 1.0 V to 4.3 V. The electrochemically inert element in a voltage range of 1.0 V to 4.3 V is, specifically, preferably an element which constitutes lithium-ion secondary batteries, have a valence that remains unchanged even in a case in which the voltage is changed in a range of 1.0 V to 4.3 V, and does not contribute to the development of charge and discharge capacities.

In the electrode material for a lithium-ion secondary battery of the present embodiment, the surfaces of the primary particles of the electrode active material A may be coated with a carbonaceous film.

The average primary particle diameter of the primary particles of the electrode active material A made of LiFeₓMn_{1-x-y}M_{y}PO₄ is preferably 65 nm or more and 400 nm or less and more preferably 75 nm or more and 270 nm or less.

Here, the reasons for setting the average primary particle diameter of LiFeₓMn_{1-x-y}M_{y}PO₄ particles in the above-described range are as described below. When the average primary particle diameter of the LiFeₓMn_{1-x-y}M_{y}PO₄ particles is less than 65 nm, the specific surface area of the electrode active material A having the carbonaceous film increases, and thus the amount of necessary carbon increases, the charge and discharge capacity decreases, carbon coating becomes difficult, it is not possible to obtain primary particles having a sufficient coating ratio, and a favorable discharge capacity or mass energy density cannot be obtained particularly at a low temperature or during high-speed charge and discharge. On the other hand, when the average primary particle diameter of LiFeₓMn_{1-x-y}M_{y}PO₄ particles exceeds 400 nm, it takes a long time for lithium ions or electrons to migrate in the electrode active material A having the carbonaceous film, and thus the internal resistance increases, and the output characteristics deteriorate, which is not preferable.

In the electrode material for a lithium-ion secondary battery of the present embodiment, the average primary particle diameter of the respective particles can be obtained from scanning electron microscopic images obtained by observing the respective particles using a scanning electron microscope (SEM) (trade name: S-4800, manufactured by Hitachi High-Technologies Corporation).

The thickness of the carbonaceous film is preferably 1 nm or more and 12 nm or less.

The reasons for setting the thickness of the carbonaceous film in the above-described range are as described below. When the thickness of the carbonaceous film is less than 1 nm, the thickness of the carbonaceous film is too thin, and thus it becomes impossible to form films having a desired resistance value, consequently, the electrical conductivity decreases, and it becomes impossible to ensure electrical conductivity suitable for electrode materials. On the other hand, when the thickness of the carbonaceous film exceeds 12 nm, battery activity, for example, the battery capacity of the electrode material per unit mass, decreases.

The average primary particle diameter of the primary particles of the electrode active material A made of LiFeₓMn_{1-x-y}M_{y}PO₄ which are coated with the carbonaceous film is preferably 65 nm or more and 400 nm or less and more preferably 75 nm or more and 270 nm or less.

Here, the reasons for setting the average primary particle diameter of the primary particles of the electrode active material A made of LiFeₓMn_{1-x-y}M_{y}PO₄ which are coated with the carbonaceous film in the above-described range are as described below. When the average primary particle diameter is less than 65 nm, the specific surface area of carbonaceous electrode active material composite particles increases, and thus the mass of necessary carbon increases, the charge and discharge capacity decreases, carbon coating becomes difficult, it is not possible to obtain primary particles having a sufficient coating ratio, and a favorable discharge capacity or mass energy density cannot be obtained particularly at a low temperature or during high-speed charge and discharge. On the other hand, when the average primary particle diameter exceeds 400 nm, it takes a long time for lithium ions or electrons to migrate among the carbonaceous electrode active material composite particles, and thus the internal resistance increases, and the output characteristics deteriorate, which is not preferable.

The shape of the primary particle of the electrode active material A made of LiFeₓMn_{1-x-y}M_{y}PO₄ which is coated with the carbonaceous film is not particularly limited, but is preferably a spherical shape since it is easy to generate electrode materials made of spherical particles, particularly, truly spherical particles.

Here, the reasons for the shape being preferably a spherical shape are as described below. It is possible to decrease the amount of a solvent when the primary particles of the electrode active material A which are coated with the carbonaceous film, an electrode active material B described below, a binding agent, and the solvent are mixed together so as to prepare electrode material paste for a lithium-ion secondary battery, and it also becomes easy to apply the electrode material paste for a lithium-ion secondary battery to the electrode current collector. In addition, when the shape of the primary particle is a spherical shape, the surface area of the primary particles of the electrode active material A is minimized, furthermore, it is possible to minimize the mixing amount of the binding agent added, and the internal resistance of electrodes to be obtained can be decreased.

Furthermore, when the shape of the primary particle of the electrode active material A is set to be a spherical shape, particularly, a truly spherical shape, it becomes easy to closely pack the primary particles, and thus the amount of the electrode material for a lithium-ion secondary battery packed per unit volume increases, consequently, an electrode density can be increased, and it is possible to increase the capacity of the lithium-ion secondary battery, which is preferable

In addition, the ratio of the carbon supporting amount relative to the specific surface area of the primary particles of the electrode active material A ([the carbon supporting amount]/[the specific surface area of the primary particles of the electrode active material A]) is preferably 0.04 or more and 0.40 or less and more preferably 0.07 or more and 0.30 or less.

Here, the reasons for limiting the carbon supporting amount in the electrode material for a lithium-ion secondary battery of the present embodiment in the above-described range are as described below. When the carbon supporting amount is less than 0.04, the discharge capacity at a high charge-discharge rate decreases in a case in which batteries are formed, and it becomes difficult to realize sufficient charge and discharge rate performance. On the other hand, when the carbon supporting amount exceeds 0.40, the amount of carbon becomes too large, and the battery capacity of lithium-ion batteries per unit mass of the primary particles of the electrode active material decreases.

In the electrode active material A, as described above, the volume change percentage due to the absorption and emission of lithium ions is 6.2% or more and 8.3% or less. The electrode active material A has a greater volume change percentage than the electrode active material B described below.

Electrode Active Material B

The electrode active material B is made of a lithium-containing metal oxide. Examples of the lithium-containing metal oxide include lamellar-structured three-component (Ni, Co, and Mn)-based metal oxides (NMC) represented by a general formula Li₁₊ₐNi_{b}Mn_{c}Co_{d}O₂ (0≦a<0.5, 0<b<1, 0<c≦0.5, 0<d≦0.4, b+c+d=1), lithium manganite (LiMn2O4, hereinafter, also referred to as “LMO”), and the like.

Examples of NMC include LiNi_{0.5}Co_{0.3}Mn_{0.2}O₂ and LiNi_{0.4}CO_{0.3}Mn_{0.3}O₂.

The average primary particle diameter of the primary particles of the electrode active material B made of the lithium-containing metal oxide is preferably 0.5 μm or more and 20 μm or less and more preferably 0.8 μm or more and 10 μm or less.

Here, the reasons for setting the average primary particle diameter of the lithium-containing metal oxide particles in the above-described range are as described below. When the average primary particle diameter of the lithium-containing metal oxide particles is less than 0.5 μm, the particles are too fine, thus, powder packing properties degrade, and thus a sufficient electrode density cannot be obtained, and the volume energy density of the electrode decreases. On the other hand, when the average primary particle diameter of the lithium-containing metal oxide particles exceeds 20 μm, the reaction area between the particles and an electrolytic solution decreases, thus, the absorption and desorption (emission) reaction of lithium ions are not easily caused, and the resistance increases or the low-temperature characteristics degrade.

In the electrode active material B, the volume change percentage due to the absorption and emission of lithium ions is 0.3% or more and 6% or less. The electrode active material B has a smaller volume change percentage than the above-described electrode active material A.

The amount of carbon included in the electrode material for a lithium-ion secondary battery of the present embodiment is preferably 0.05% by mass or more and 1.2% by mass or less and more preferably 0.07% by mass or more and 0.9% by mass or less.

Here, the reasons for limiting the amount of carbon included in the electrode material for a lithium-ion secondary battery of the present embodiment in the above-described range are as described below. When the amount of carbon is less than 0.05% by mass, the discharge capacity of the electrode active material A portion is decreased in a case in which batteries are formed, and it becomes difficult to realize sufficient charge and discharge capacity performance. On the other hand, when the amount of carbon exceeds 1.2% by mass, the amount of carbon is too large, and the battery capacity of a lithium-ion battery per unit mass of the primary particles of the electrode active material decreases more than necessary.

In the electrode material for a lithium-ion secondary battery of the present embodiment, the amount of carbon is measured using a carbon analyzer (for example, trade name: EMIA-220V, manufactured by Horiba Ltd.).

Method for Manufacturing Electrode Material for Lithium-Ion Secondary Battery

A method for manufacturing an electrode material for a lithium-ion secondary battery of the present embodiment is not particularly limited, and examples thereof include a method including a step of synthesizing LiFeₓMn_{1-x-y}M_{y}PO₄ particles under pressure by heating a raw material slurry A obtained by mixing a Li source, a P source, a Fe source, a Mn source, and an M source with a solvent including water as a main component at a temperature in a range of 120° C. or higher and 250° C. or lower, a step of coating the surfaces of the LiFeₓMn_{1-x-y}M_{y}PO₄ particles (primary particles) with a carbonaceous film by drying a raw material slurry B obtained by dispersing the LiFeₓMn_{1-x-y}M_{y}PO₄ particles in a water solvent including a water-soluble viscosity improver so as to granulate the slurry and then heating the slurry at a temperature in a range of 550° C. or higher and 820° C. or lower, and step of mixing the LiFeₓMn_{1-x-y}M_{y}PO₄ particles coated with the carbonaceous film and lithium-containing metal oxide particles (primary particles) in a dry manner.

The method for synthesizing the LiFeₓMn_{1-x-y}M_{y}PO₄ particles is not particularly limited; however, for example, the Li source, the P source, the Fe source, the Mn source, and the M source are injected into the solvent including water as a main component and are stirred, thereby preparing the raw material slurry A including a precursor of the LiFeₓMn_{1-x-y}M_{y}PO₄.

The Li source, the P source, the Fe source, the Mn source, and the M source are injected into the solvent including water as a main component so that the molar ratios thereof (the Li source:the P source:the Fe source:the Mn source:the M source), that is, the molar ratios of Li:P:Fe:Mn:M reaches 1.8 to 3.5:0.9 to 1.3:0.05 to 0.35:0.49 to 0.945:0 to 0.14 and are stirred and mixed together, thereby preparing the raw material slurry A.

When uniform mixing is taken into account, the Li source, the P source, the Fe source, the Mn source, and the M source are preferably mixed after the Li source, the P source, the Fe source, the Mn source, and the M source are, first, put into an aqueous solution state respectively.

The molar concentrations of the Li source, the P source, the Fe source, the Mn source, and the M source in the raw material slurry A are preferably 1.1 mol/L or more and 2.2 mol/L or less since it is necessary to obtain high-purity, highly crystalline, and extremely fine LiFeₓMn_{1-x-y}M_{y}PO₄ particles.

Examples of the Li source include hydroxides such as lithium hydroxide (LiOH), inorganic lithium acid salts such as lithium carbonate (Li₂CO₃), lithium chloride (LiCl), lithium nitrate (LiNO₃), lithium phosphate (Li₃PO₄), lithium hydrogen phosphate (Li₂HPO₄), and lithium dihydrogen phosphate (LiH₂PO₄), organic lithium acid salts such as lithium acetate (LiCH₃COO) and lithium oxalate ((COOLi)₂), and hydrates thereof. As the Li source, at least one selected from the above-described group is preferably used.

Meanwhile, lithium phosphate (Li₃PO₄) can also be used as the Li source and the P source.

As the P source, for example, at least one compound selected from phosphoric acids such as orthophosphoric acid (H₃PO₄) and metaphosphoric acid (HPO₃), phosphoric salts such as ammonium dihydrogen phosphate (NH₄H₂PO₄), diammonium hydrogen phosphate ((NH₄)₂HPO₄), ammonium hydrogen phosphate ((NH₄)₃PO₄), lithium phosphate (Li₃PO₄), lithium hydrogen phosphate (Li₂HPO₄), and lithium dihydrogen phosphate (LiH₂PO₄), and hydrates thereof is preferably used.

As the Fe source, for example, iron compounds such as iron (II) chloride (FeCl₂), iron (II) sulfate (FeSO₄), and iron (II) acetate (Fe(CH₃COO)₂) or hydrates thereof, trivalent iron compounds such as iron (III) nitrate (Fe(NO₃)₃), iron (III) chloride (FeCl₃), and iron (III) citrate (FeC₆H₅O₇), lithium iron phosphate, or the like can be used.

The Mn source is preferably an Mn salt, and examples thereof include manganese (II) chloride (MnCl₂), manganese (II) sulfate (MnSO₄), manganese (II) nitrate (Mn (NO₃)₂), manganese (II) acetate (Mn (CH₃COO)₂), and hydrates thereof. As the Mn source, at least one compound selected from the above-described group is preferably used.

Examples of the M source include chlorides, carboxylates, hydrosulfates, and the like which include at least one element selected from the group consisting of Mg, Ca, Co, Sr, Ba, Ti, Zn, B, Al, Ga, In, Si, Ge, and rare earth elements.

The solvent including water as a main component is any one of water alone and water-based solvents which include water as a main component and include an aqueous solvent such as an alcohol as necessary.

The aqueous solvent is not particularly limited as long as the solvent is capable of dissolving the Li source, the P source, the Fe source, the Mn source, and the M source, and examples thereof include alcohols such as methanol, ethanol, 1-propanol, 2-propanol (isopropyl alcohol: IPA), butanol, pentanol, hexanol, octanol, and diacetone alcohol, esters such as ethyl acetate, butyl acetate, ethyl lactate, propylene glycol monomethyl ether acetate, propylene glycol monoethyl ether acetate, and γ-butyrolactone, ethers such as diethyl ether, ethylene glycol monomethyl ether (methyl cellosolve), ethylene glycol monoethyl ether (ethyl cellosolve), ethylene glycol monobutyl ether (butyl cellosolve), diethylene glycol monomethyl ether, and diethylene glycol monoethyl ether, ketones such as acetone, methyl ethyl ketone (MEK), methyl isobutyl ketone (MIBK), acetyl acetone, and cyclohexanone, amides such as dimethyl formamide, N,N-dimethylacetoacetamide, and N-methyl pyrrolidone, glycols such as ethylene glycol, diethylene glycol, and propylene glycol, and the like. These aqueous solvents may be used singly or a mixture of two or more aqueous solvents may be used

Next, this raw material slurry A is put into a pressure resistant vessel, is heated to a temperature in a range of 120° C. or higher and 250° C. or lower and preferably in a range of 160° C. or higher and 220° C. or lower, and is hydrothermally treated for one hour to 24 hours, thereby obtaining LiFeₓMn_{1-x-y}M_{y}PO₄ particles.

The pressure in the pressure resistant vessel reaches, for example, 0.3 MPa or more and 1.5 MPa or less when the raw material slurry reaches the temperature in a range of 120° C. or higher and 250° C. or lower.

In this case, it is possible to control the particle diameter of the LiFeₓMn_{1-x-y}M_{y}PO₄ particles to a desired size by adjusting the temperature and time during the hydrothermal treatment.

Next, the LiFeₓMn_{1-x-y}M_{y}PO₄ particles are dispersed in the water solvent including the water-soluble viscosity improver, thereby preparing the raw material slurry B.

Next, this raw material slurry B is dried so as to be granulated, and is then heated at a temperature in a range of 530° C. or higher and 850° C. or lower for 0.5 hours or longer and six hours or shorter, and the surfaces of the LiFeₓMn_{1-x-y}M_{y}PO₄ particles (primary particles) are coated with the carbonaceous film, thereby obtaining the above-described electrode active material A.

Next, the electrode active material A and the lithium-containing metal oxide particles (primary particles) are mixed together in a dry manner, thereby obtaining the electrode material for a lithium-ion secondary battery of the present embodiment.

Water-Soluble Viscosity Improver

The water-soluble viscosity improver is not particularly limited, and it is possible to use, for example, natural water-soluble polymers such as gelatin, casein, collagen, hyaluronic acid, albumin, and starch, semisynthetic polymers such as methyl cellulose, ethyl cellulose, methyl hydroxypropyl cellulose, carboxymethyl cellulose, hydroxymethyl cellulose, hydroxypropyl cellulose, carboxymethyl cellulose sodium, and propylene glycol alginade, synthetic polymers such as polyvinyl alcohol, polyvinylpyrrolidone, a carbomer (carboxyvinyl polymer), polyacrylate, and polyethylene oxide, and the like.

These water-soluble viscosity improvers may be used singly or a mixture of two or more viscosity improvers may be used.

In the method for manufacturing an electrode material for a lithium-ion secondary battery of the present embodiment, when the total mass of the electrode active material and the water-soluble viscosity improver is set to 100% by mass, the amount of the water-soluble viscosity improver added (additive rate) is preferably 1% by mass or more and 15% by mass or less and more preferably 2.5% by mass or more and 9.5% by mass or less.

When the amount of the water-soluble viscosity improver added is less than 1% by mass, mixing stability in the electrode material for a lithium-ion secondary battery degrades, which is not preferable. On the other hand, when the amount of the water-soluble viscosity improver added exceeds 15% by mass, the content of a cathode active material becomes relatively small, and battery characteristics degrade, which is not preferable.

Electrode for Lithium-Ion Secondary Battery

An electrode for a lithium-ion secondary battery of the present embodiment includes an electrode current collector and an electrode mixture layer (electrode) formed on the electrode current collector, and the electrode mixture layer includes the electrode material for a lithium-ion secondary battery of the present embodiment.

That is, the electrode for a lithium-ion secondary battery of the present embodiment is obtained by forming an electrode mixture layer on one main surface of an electrode current collector using the electrode material for a lithium-ion secondary battery of the present embodiment.

The electrode for a lithium-ion secondary battery of the present embodiment is mainly used as a cathode for a lithium-ion secondary battery.

A method for manufacturing the electrode for a lithium-ion secondary battery of the present embodiment is not particularly limited as long as the electrode can be formed on one main surface of an electrode current collector using the electrode material for a lithium-ion secondary battery of the present embodiment. Examples of the method for manufacturing the electrode for a lithium-ion secondary battery of the present embodiment include the following method.

First, the electrode material paste for a lithium-ion secondary battery is prepared by mixing the electrode material for a lithium-ion secondary battery of the present embodiment, a binding agent, a conductive auxiliary agent, and a solvent.

Binding Agent

The binding agent is not particularly limited as long as the binding agent can be used in a water system, and examples thereof include at least one binding agent selected from the group of polyethylene, polypropylene, polyethylene terephthalate, polymethyl methacrylate, vinyl acetate copolymers, styrene/butadiene-based latexes, acrylic latexes, acrylonitrile/butadiene-based latexes, fluorine-based latexes, silicon-based latexes, and the like.

When the total mass of the electrode material for a lithium-ion secondary battery of the present embodiment, the binding agent, and the conductive auxiliary agent is set to 100% by mass, the content rate of the binding agent in the electrode material paste for a lithium-ion secondary battery is preferably 1% by mass or more and 15% by mass or less and more preferably 3% by mass or more and 9% by mass or less.

Here, the reasons for setting the content rate of the binding agent in the above-described range are as described below. When the content rate of the binding agent is less than 1% by mass, in a case in which an electrode mixture layer is formed using the electrode material paste for a lithium-ion secondary battery including the electrode material for a lithium-ion secondary battery of the present embodiment, the bonding properties between the electrode mixture layer and the electrode current collector are not sufficient, and there are cases in which cracking or dropping of the electrode mixture layer occurs during the rolling formation of the electrode mixture layer, which is not preferable. In addition, there are cases in which the electrode mixture layer is peeled off from the electrode current collector in the charge and discharge process of batteries and battery capacities or charge-discharge rates decrease, which is not preferable. On the other hand, when the content rate of the binding agent exceeds 15% by mass, the internal resistance of the electrode material for a lithium-ion secondary battery increases, and there are cases in which battery capacities at high charge-discharge rate decrease, which is not preferable.

Conductive Auxiliary Agent

The conductive auxiliary agent is not particularly limited, and, for example, at least one element selected from the group of fibrous carbon such as acetylene black (AB), KETJEN BLACK, furnace black, vapor-grown carbon fiber (VGCF), and carbon nanotube is used.

When the total mass of the electrode material for a lithium-ion secondary battery of the present embodiment, the binding agent, and the conductive auxiliary agent is set to 100% by mass, the content rate of the conductive auxiliary agent in the electrode material paste for a lithium-ion secondary battery is preferably 1% by mass or more and 15% by mass or less and more preferably 3% by mass or more and 10% by mass or less.

Here, the reasons for setting the content rate of the conductive auxiliary agent in the above-described range are as described below. When the content rate of the conductive auxiliary agent is less than 1% by mass, in a case in which the electrode mixture layer is formed using the electrode material paste for a lithium-ion secondary battery including the electrode material for a lithium-ion secondary battery of the present embodiment, the electron conductivity is not sufficient, and battery capacities or charge and discharge rates decrease, which is not preferable. On the other hand, when the content of the conductive auxiliary agent exceeds 15% by mass, the relative proportion of the electrode material in the electrode mixture layer decreases, and the battery capacity of lithium-ion batteries per unit volume decreases, which is not preferable.

Solvent

To the electrode material paste for a lithium-ion secondary battery including the electrode material for a lithium-ion secondary battery of the present embodiment, a solvent is appropriately added in order to facilitate coating of an article to be coated such as an electrode current collector.

A principal solvent is water, but water-based solvents such as alcohols, glycols, and ethers may be added thereto as long as the characteristics of the electrode material for a lithium-ion secondary battery of the present embodiment are not lost.

The content rate of the solvent in the electrode material paste for a lithium-ion secondary battery is preferably 80% by mass or more and 300% by mass or less and more preferably 100% by mass or more and 250% by mass or less in a case in which the total mass of the electrode material for a lithium-ion secondary battery of the present embodiment, the binding agent, the conductive auxiliary agent, and the solvent is set to 100% by mass.

When the solvent is included in the above-described range, it is possible to obtain an electrode material paste for a lithium-ion secondary battery having excellent electrode formability and excellent battery characteristics.

A method for mixing the electrode material for a lithium-ion secondary battery of the present embodiment, the binding agent, the conductive auxiliary agent, and the solvent is not particularly limited as long as it is possible to uniformly mix the above-described components. Examples thereof include methods in which a kneader such as a ball mill, a sand mill, a planetary mixer, a paint shaker, or a homogenizer is used.

Next, the electrode material paste for a lithium-ion secondary battery is applied onto one main surface of the electrode current collector so as to form a coated film, this coated film is dried and then pressed, whereby it is possible to obtain an electrode for a lithium-ion secondary battery which has the electrode mixture layer formed on one main surface of the electrode current collector.

Lithium-Ion Secondary Battery

A lithium-ion secondary battery of the present embodiment includes the electrode for a lithium-ion secondary battery of the present embodiment (cathode), an anode, a separator, and an electrolytic solution.

In the lithium-ion secondary battery of the present embodiment, the anode, the electrolytic solution, the separator, and the like are not particularly limited.

As the anode, for example, an anode material such as metallic Li, a carbon material, a Li alloy, or Li₄Ti₅O₁₂ can be used.

In addition, instead of the electrolytic solution and the separator, a solid electrolyte may also be used.

The electrolytic solution can be produced by, for example, mixing ethylene carbonate (EC) and ethyl methyl carbonate (EMC) so that the volume ratio therebetween reaches 1:1, and dissolving lithium hexafluorophosphate (LiPF₆) in the obtained solvent mixture so that the concentration thereof reaches, for example, 1 mol/dm³.

As the separator, it is possible to use, for example, porous propylene.

In the lithium-ion secondary battery of the present embodiment, since the electrode for a lithium-ion secondary battery of the present embodiment is used as the cathode, the lithium-ion secondary battery has a high capacity and a high energy density.

As described above, according to the electrode material for a lithium-ion secondary battery of the present embodiment, in lithium-ion secondary batteries including an electrode for a lithium-ion secondary battery including the electrode material for a lithium-ion secondary battery, the structure of the electrode material for a lithium-ion secondary battery is stable in a charged state, and thus heat generation or ignition is suppressed, and it is possible to improve safety. In addition, it is possible to improve the service lives of lithium-ion secondary batteries. In addition, according to the electrode material for a lithium-ion secondary battery of the present embodiment, since the volume change percentage of the electrode active material A due to the absorption and emission of lithium ions is small, lithium-ion secondary batteries including an electrode for a lithium-ion secondary battery including the electrode material for a lithium-ion secondary battery do not lose electrical conductivity due to the volume change of the electrode active material A included in the electrode material for a lithium-ion secondary battery in the middle of charge and discharge, and it is possible to improve the service lives of batteries.

According to the electrode for a lithium-ion secondary battery of the present embodiment, since the electrode material for a lithium-ion secondary battery of the present embodiment is included, it is possible to provide cathodes for a lithium-ion secondary battery which have improved safety and are capable of improving the service lives of batteries.

According to the lithium-ion secondary battery of the present embodiment, since the electrode for a lithium-ion secondary battery of the present embodiment is included, it is possible to provide lithium-ion secondary batteries having improved safety and a long service life.

### EXAMPLES

Hereinafter, the present invention will be more specifically described using examples and comparative examples, but the present invention is not limited to the following examples.

### Example 1

Synthesis of Electrode Material for Lithium-Ion Secondary Battery

LiFe_{0.27}Mn_{0.70}Mg_{0.03}PO₄ was synthesized in the following manner.

Li₃PO₄ as a Li source and a P source, an aqueous solution of FeSO₄ as a Fe source, an aqueous solution of MnSO₄ as a Mn source, and an aqueous solution of MgSO₄ as a Mg source were used, and these components were mixed together so that the molar ratios thereof reached Li:Fe:Mn:Mg:P=3:0.27:0.70:0.03:1, thereby preparing 2.2 L of a raw material slurry A.

Next, this raw material slurry A was put into a pressure resistant vessel.

After that, a heating reaction was performed on this raw material slurry A at 200° C. for six hours, thereby carrying out hydrothermal synthesis. The pressure in the pressure resistant vessel at this time was 1.2 MPa.

After the reaction, the atmosphere in the pressure resistant vessel was cooled to room temperature, thereby obtaining a cake-state precipitate of a reaction product.

This precipitate was sufficiently cleaned with distilled water a plurality of times, and the water content ratio thereof was maintained at 40% so as to prevent the precipitate from being dried, thereby producing a cake-form substance.

This cake-form substance was dried in a vacuum at 70° C. for two hours, a raw material slurry B obtained by dispersing polyvinyl alcohol (4% by mass) in a water solvent, the content of which had been adjusted in advance to 20% by mass relative to 96% by mass of the obtained LiFe_{0.27}Mn_{0.70}Mg_{0.03}PO₄(LFMP: corresponding to the electrode active material A in the present invention) particles, was dried and granulated, and then a thermal treatment was carried out at 750° C. for one hour, thereby coating the surfaces of the LFMP particles with a carbonaceous film. The LFMP particles coated with the carbonaceous film (10% by mass) and LiNi_{0.5}Co_{0.3}Mn_{0.2}O₂ particles (90% by mass) were put into a 250 mL polypropylene wide-mouth container so that the total weight reached 150 g and were treated at a rotation speed of 100 rpm for eight hours using a bench ball mill mount of Asahi Rika Seisakusho so as to be mixed in a dry manner, thereby obtaining an electrode material for a lithium-ion secondary battery of Example 1.

Production of Lithium-Ion Secondary Battery

The electrode material for a lithium-ion secondary battery, polyvinylidene fluoride (PVdF) as a binding agent, and acetylene black (AB) as a conductive auxiliary agent were added to N-methyl-2-pyrrolidone (NMP) which was a solvent so that the mass ratio therebetween (the electrode material:AB:PVdF) in paste reached 90:5:5, and the components were mixed together, thereby preparing electrode material paste for a lithium-ion secondary battery.

Next, this electrode material paste for a lithium-ion secondary battery was applied to a surface of a 30 μm-thick aluminum foil (electrode current collector) so as to form a coated film, and the coated film was dried, thereby forming an electrode mixture layer on the surface of the aluminum foil. After that, the electrode mixture layer was pressed under a predetermined pressure so as to obtain a predetermined density, thereby producing a cathode for a lithium-ion secondary battery of Example 1.

Next, a circular plate having a diameter of 16 mm was produced from the cathode for a lithium-ion secondary battery using a shaping machine by means of punching, was dried in a vacuum, and then a lithium-ion secondary battery of Example 1 was produced using a stainless steel (SUS) 2016 coil cell in a dried argon atmosphere.

Metallic lithium was used as an anode, a porous polypropylene film was used as a separator, and a LiPF₆ solution (1 M) was used as an electrolytic solution. As the LiPF₆ solution, a solution obtained by mixing ethylene carbonate and ethyl methyl carbonate so that the volume ratio therebetween reached 1:1 was used.

Lattice volume evaluation of electrode materials for lithium-ion secondary battery in lithium-ion secondary batteries in non-charged state and charged state

1. Adjustment of Lattice Volume Evaluation Samples

Lattice volume evaluation samples of the electrode materials for a lithium-ion secondary battery in the electrodes for a lithium-ion secondary battery produced in the above-described manner were adjusted as described below.

As a sample in a lithium ion absorption state, the produced battery was disassembled, the cathode was removed, and the battery was used.

As a sample in a lithium ion desorption state, the battery was constant-current-charged at a current value of 1 CA until the voltage of the cathode reached 4.8 V relative to the equilibrium voltage of Li at an ambient temperature of 25° C. and was constant-voltage-charged until the current value reached 0.1 CA after the voltage reached 4.8 V. After that, the battery was disassembled, the cathode was removed, and the battery was used as the sample in a lithium ion desorption state.

For the respective cathodes removed in the above-described manner, an electrolytic solution attached to the cathodes was cleaned using a diethyl carbonate solvent, and the solvent was removed by drying the cathodes at normal temperature under pressure for eight hours, thereby producing lattice volume evaluation samples.

2. Volume Change Percentage

The electrode material for a lithium-ion secondary battery in an electrode for a lithium-ion secondary battery in a lithium ion absorption state and the electrode material for a lithium-ion secondary battery in an electrode for a lithium-ion secondary battery in a lithium ion desorption state were evaluated using an X-ray diffraction device (trade name: X′Pert PRO MPS, manufactured by PANalytical, radiation source: CuKa), the lattice constants of LFMP in a non-charged state and in a charged state were computed from X-ray diffraction patterns using a relationship between the lattice constant and the lattice spacing in rhombic system crystals (1/d²=h²/a²+k²/b²+l²/c², d: lattice spacing, h, k, l: plane indices, a, b, c: lattice constants), and the lattice volumes were respectively computed from the products of the lattice constants a, b, and c. In addition, the volume change percentage of LFMP was computed using (the lattice volume in a lithium ion desorption state)/(the lattice volume in a lithium ion absorption state). The evaluation results are shown in Table 1.

Evaluation of Lithium-Ion Secondary Batteries

Capacity Retention

The capacity retention of the lithium-ion secondary battery was evaluated.

The battery was constant-current-charged at a current value of 1 CA until the voltage of the cathode reached 4.8 V relative to the equilibrium voltage of Li at an ambient temperature of 25° C. and was constant-voltage-charged until the current value reached 0.1 CA after the voltage reached 4.8 V. After that, the cycle was rested for one minute, 1CA constant current discharging was carried out until the voltage of the cathode reached 2.5 V relative to the equilibrium voltage of Li at an ambient temperature of 25° C. This test was repeated 300 cycles, and the discharge capacity at the 300^{th} cycle relative to the discharge capacity at the first cycle was considered as the capacity retention. The evaluation results are shown in Table 1.

### Example 2

LiFe_{0.25}Mn_{0.70}Mg_{0.05}PO₄ (corresponding to the electrode active material A in the present invention) was synthesized in the same manner as Example 1 except for the fact that Li₃PO₄ as the Li source and the P source, an aqueous solution of FeSO₄ as the Fe source, an aqueous solution of MnSO₄ as the Mn source, and an aqueous solution of MgSO₄ as the Mg source were used, and these components were mixed together so that the molar ratios thereof (Li:Fe:Mn:Mg:P) reached 3:0.25:0.70:0.05:1, thereby preparing the raw material slurry A.

Hereinafter, an electrode material for a lithium-ion secondary battery of Example 2 was synthesized in the same manner as in Example 1.

In addition, a lithium-ion secondary battery of Example 2 was produced in the same manner as in Example 1 except for the fact that the electrode material for a lithium-ion secondary battery of Example 2 was used.

### Example 3

LiFe_{0.2498}Mn_{0.70}Mg_{0.045}Co_{0.005}Ca_{0.0002}PO₄ (corresponding to the electrode active material A in the present invention) was synthesized in the same manner as Example 1 except for the fact that Li₃PO₄ as the Li source and the P source, an aqueous solution of FeSO₄ as the Fe source, an aqueous solution of MnSO₄ as the Mn source, an aqueous solution of MgSO₄ as the Mg source, an aqueous solution of CoSO₄ as a Co source, and an aqueous solution of CaSO₄ as a Ca source were used, and these components were mixed together so that the molar ratios thereof (Li:Fe:Mn:Mg:Co:Ca:P) reached 3:0.2498:0.70:0.045:0.005:0.0002:1, thereby preparing the raw material slurry A.

Hereinafter, an electrode material for a lithium-ion secondary battery of Example 3 was synthesized in the same manner as in Example 1.

In addition, a lithium-ion secondary battery of Example 3 was produced in the same manner as in Example 1 except for the fact that the electrode material for a lithium-ion secondary battery of Example 3 was used.

### Example 4

LiFe_{0.2498}Mn_{0.70}Mg_{0.045}Co_{0.005}Ca_{0.0002}PO₄ (corresponding to the electrode active material A in the present invention) was synthesized in the same manner as Example 3.

In addition, a lithium-ion secondary battery of Example 4 was produced in the same manner as in Example 1 except for the fact that the LFMP particles coated with the carbonaceous film (15% by mass) and LiNi_{0.5}Co_{0.3}Mn_{0.2}O₂ particles (85% by mass) were mixed together.

### Comparative Example 1

A raw material slurry obtained by dispersing polyvinyl alcohol (4% by mass) in a water solvent, the content of which had been adjusted in advance to 20% by mass relative to 96% by mass of LiMnPO₄ (LMP: corresponding to the electrode active material A in the present invention) particles, was dried and granulated, and then a thermal treatment was carried out at 750° C. for one hour, thereby coating the surfaces of the LMP particles with a carbonaceous film. An electrode material for a lithium-ion secondary battery of Comparative Example 1 was obtained in the same manner as in Example 1 except for the fact that the LMP particles in Comparative Example 1 were used instead of the LFMP particles.

In addition, a lithium-ion secondary battery of Comparative Example 1 was produced in the same manner as in Example 1 except for the fact that the electrode material for a lithium-ion secondary battery of Comparative Example 1 was used.

### Comparative Example 2

LiFe_{0.3}Mn_{0.7}PO₄ (corresponding to the electrode active material A in the present invention) was synthesized in the same manner as Example 1 except for the fact that Li₃PO₄ as the Li source and the P source, an aqueous solution of FeSO₄ as the Fe source, and an aqueous solution of MnSO₄ as the Mn source were used, and these components were mixed together so that the molar ratios thereof (Li:Fe:Mn:P) reached 1:0.3:0.7:1:1, thereby preparing the raw material slurry A.

Hereinafter, an electrode material for a lithium-ion secondary battery of Comparative Example 2 was synthesized in the same manner as in Example 1.

In addition, a lithium-ion secondary battery of Comparative Example 2 was produced in the same manner as in Example 1 except for the fact that the electrode material for a lithium-ion secondary battery of Comparative Example 2 was used.

### Comparative Example 3

An electrode material for a lithium-ion secondary battery of Comparative Example 3 was obtained in the same manner as in Example 1 except for the fact that the LiFe_{0.27}Mn_{0.70}Mg_{0.03}PO₄ (corresponding to the electrode active material A in the present invention) particles coated with the carbonaceous film (3% by mass) and LiNi_{0.5}Co_{0.3}Mn_{0.2}O₂ particles (97% by mass) were mixed together.

In addition, a lithium-ion secondary battery of Comparative Example 3 was produced in the same manner as in Example 1 except for the fact that the electrode material for a lithium-ion secondary battery of Comparative Example 3 was used.

Evaluation of Electrode Materials for Lithium-Ion Secondary Battery

Volume Change Percentage

In the electrode materials for a lithium-ion secondary battery of Examples 2 to 4 and Comparative Examples 1 to 3, the volume change percentages of the substances corresponding to the electrode active material A were measured in the same manner as in Example 1. The evaluation results are shown in Table 1.

Evaluation of Lithium-Ion Secondary Batteries

Capacity Retention

The capacity retentions of the lithium-ion secondary batteries of Examples 2 to 4 and Comparative Examples 1 to 3 were measured in the same manner as in Example 1. The evaluation results are shown in Table 1.

TABLE 1

| | | | Volume | |
|---|---|---|---|---|
| | | Content | change | |
| | | of | percentage | |
| | | electrode | of | |
| | | active | electrode | |
| | | material A | active | Capacity |
| | | [% by | material A | retention |
| | Composition | mass] | [%] | [%] |
| Example 1 | NMC/LiFe_{0.27}Mn_{0.70}Mg_{0.03}PO₄ | 10 | 8.24 | 78.7 |
| Example 2 | NMC/LiFe_{0.25}Mn_{0.70}Mg_{0.05}PO₄ | 10 | 8.11 | 79.4 |
| Example 3 | NMC/LiFe_{0.2498}Mn_{0.70}Mg_{0.045}Co_{0.005}Ca_{0.0002}PO₄ | 10 | 7.91 | 81.6 |
| Example 4 | NMC/LiFe_{0.2498}Mn_{0.70}Mg_{0.045}Co_{0.005}Ca_{0.0002}PO₄ | 15 | 7.91 | 85.3 |
| Comparative | NMC/LiMnPO₄ | 10 | 11.3 | 58.4 |
| Example 1 | | | | |
| Comparative | NMC/LiFe_{0.3}Mn_{0.7}PO₄ | 10 | 8.52 | 72.1 |
| Example 2 | | | | |
| Comparative | NMC/LiFe_{0.27}Mn_{0.70}Mg_{0.03}PO₄ | 3 | 8.24 | 71.7 |
| Example 3 | | | | |

From the results in Table 1, it could be confirmed that, in the electrode materials for a lithium-ion secondary battery of Examples 1 to 4, the volume change percentages of the substances corresponding to the electrode active material A were 7.91% to 8.24% and the contents of LFMP were 10% by mass to 15% by mass, and thus the capacity retentions of lithium-ion secondary batteries for which these electrode materials for a lithium-ion secondary battery were used were 78.7% to 85.3%.

On the other hand, it could be confirmed that the electrode material for a lithium-ion secondary battery of Comparative Example 1 was a material obtained by mixing NMC and LiMnPO₄, and thus the volume change percentage of the substance corresponding to the electrode active material A was as high as 11.3% even when the content of LiMnPO₄ was 10% by mass. In addition, the capacity retention of the lithium-ion secondary battery for which this electrode material for a lithium-ion secondary battery was used was as low as 58.4%.

In addition, it could be confirmed that the electrode material for a lithium-ion secondary battery of Comparative Example 2 was a material obtained by mixing NMC and LiFeMnPO₄, and thus the volume change percentage of the substance corresponding to the electrode active material A was as high as 8.52% even when the content of LiFeMnPO₄ was 10% by mass. In addition, the capacity retention of the lithium-ion secondary battery for which this electrode material for a lithium-ion secondary battery was used was as low as 72.1%.

Furthermore, it could be confirmed that the electrode material for a lithium-ion secondary battery of Comparative Example 3 included LFMP having the same composition as in Example 1, but the content thereof was 3% by mass, and thus the capacity retention of the lithium-ion secondary battery for which this electrode material for a lithium-ion secondary battery was used was as low as 71.7%.

Since the electrode material for a lithium-ion secondary battery of the present invention is a mixture including an electrode active material A made of LiFeₓMn_{1-x-y}M_{y}PO₄ (0.05≦x≦0.40, 0≦y≦0.14, 1−x−y≧0, here, M represents at least one element selected from the group consisting of Mg, Ca, Co, Sr, Ba, Ti, Zn, B, Al, Ga, In, Si, Ge, and rare earth elements) and an electrode active material B made of a lithium-containing metal oxide, in which a volume change percentage due to lithium ions absorbed into and emitted from the electrode active material A is 6.2% or more and 8.3% or less, lithium-ion secondary batteries including an electrode for a lithium-ion secondary battery produced using this electrode material for a lithium-ion secondary battery have improved safety and a long service life, and thus the electrode material for a lithium-ion secondary battery can also be applied to next-generation secondary batteries that are expected to have a higher voltage, a higher energy density, higher load characteristics, and higher-speed charge and discharge characteristics, and, in the case of next-generation secondary batteries, the effects are extremely great.

1. An electrode material for a lithium-ion secondary battery which is a mixture including: an electrode active material A made of LiFeₓMn_{1-x-y}M_{y}PO₄, wherein 0.05≦x≦0.40, 0≦y≦0.14, 1−x−y≧0, and M represents at least one element selected from the group consisting of Mg, Ca, Co, Sr, Ba, Ti, Zn, B, Al, Ga, In, Si, Ge, and rare earth elements; and an electrode active material B made of a lithium-containing metal oxide,
wherein a volume change percentage due to lithium ions absorbed into and emitted from the electrode active material A is 6.2% to 8.3%.

2. The electrode material for a lithium-ion secondary battery according to claim 1,
wherein a content of the electrode active material A is 5% by mass to 40% by mass.

3. The electrode material for a lithium-ion secondary battery according to claim 1,
wherein a capacity retention represented by [discharge capacity at the 300^{th} cycle]/[discharge capacity at the first cycle] at 25° C. and a 1CA discharge capacity is 75% to 95%.

4. An electrode for a lithium-ion secondary battery comprising:
an electrode current collector; and
an electrode mixture layer formed on the electrode current collector,
wherein the electrode mixture layer includes the electrode material for a lithium-ion secondary battery according to claim 1.

5. A lithium-ion secondary battery comprising:
the electrode for a lithium-ion secondary battery according to claim 4.
